(19) United States
(12) Patent Application Publication
(10) Pub. No.: US 2023/0039434 A1
(43) Pub. Date: Feb. 9, 2023

(54) COMMUNICATION DEVICE AND POSITION IDENTIFICATION METHOD

(71) Applicant: KABUSHIKI KAISHA TOKAI RIKA DENKI SEISAKUSHO, Aichi (JP)

(72) Inventors: Yosuke OHASHI, Aichi (JP); Masateru FURUTA, Aichi (JP); Yuki KONO, Aichi (JP); Shigenori NITTA, Aichi (JP)

(73) Assignee: KABUSHIKI KAISHA TOKAI RIKA DENKI SEISAKUSHO, Aichi (JP)

(21) Appl. No.: 17/790,314

(22) PCT Filed: Dec. 3, 2020
(86) PCT No.: PCT/JP2020/044974

§ 371 Date: Jun. 30, 2022

(30) Foreign Application Priority Data
Mar. 23, 2020 (JP) 2020-051715

(51) Int. Cl. G01S 5/10; H04W 64/00

(52) U.S. Cl. CPC G01S 5/10; H04W 64/003; B60R 25/24

(57) ABSTRACT

A communication device includes: a plurality of wireless communication units configured to perform wireless communication with another communication device; and a control unit configured to identify position information indicating a position at which the other communication device is located on the basis of at least three distance measurement results indicating a distance between each of at least three wireless communication units and the other communication device obtained in accordance with a result of wireless communication performed by each of the at least three wireless communication units among the plurality of wireless communication units.

### TECHNICAL FIELD

The present invention relates to a communication device and a position identification method.

### BACKGROUND ART

In recent years, distance measurement techniques of measuring a distance to a distance measurement target have been used for various services. For example, the following Patent Literature 1 discloses a technique of measuring a distance between a vehicle and a portable device and determining whether a door is locked or unlocked in accordance with the measured distance or warning that the door is open.

### CITATION LIST

### Patent Literature

[Patent Literature 1] JP 2014-51809A

### SUMMARY OF INVENTION

### Technical Problem

However, the technique disclosed in Patent Literature 1 merely provides a service according to a simple distance, and thus it is difficult to provide a service according to a more detailed situation.

Consequently, the present invention was contrived in view of the above problem, and an object of the present invention is to provide a mechanism that makes it possible to identify the position of a distance measurement target in more detail using a distance measurement technique.

### Solution to Problem

To solve the above described problem, according to an aspect of the present invention, there is provided a communication device comprising: a plurality of wireless communication units configured to perform wireless communication with another communication device; and a control unit configured to identify position information indicating a position at which the other communication device is located on the basis of at least three distance measurement results indicating a distance between each of at least three wireless communication units and the other communication device obtained in accordance with a result of wireless communication performed by each of the at least three wireless communication units among the plurality of wireless communication units.

To solve the above described problem, according to another aspect of the present invention, there is provided a communication device comprising: a wireless communication unit configured to perform wireless communication with each of a plurality of other wireless communication units provided in another communication device; and a control unit configured to identify position information indicating a position at which the other communication device is located on the basis of at least three distance measurement results indicating a distance between the communication device and each of at least three other wireless communication units obtained in accordance with a result of wireless communication performed between the wireless communication unit and the at least three other wireless communication units.

To solve the above described problem, according to another aspect of the present invention, there is provided a position identification method comprising identifying position information indicating a position at which another communication device is located on the basis of at least three distance measurement results indicating a distance between each of at least three wireless communication units and the other communication device obtained in accordance with a result of wireless communication performed by each of the at least three wireless communication units among a plurality of wireless communication units that perform wireless communication the other communication device.

To solve the above described problem, according to another aspect of the present invention, there is provided a position identification method comprising identifying position information indicating a position at which another communication device is located on the basis of at least three distance measurement results indicating a distance between the wireless communication unit and each of at least three other wireless communication units obtained in accordance with a result of wireless communication performed between a wireless communication unit that performs wireless communication with each of a plurality of other wireless communication units provided in the other communication device and the at least three other wireless communication units.

### Advantageous Effects of Invention

According to the present invention as described above, it is possible to provide a mechanism that makes it possible to identify the position of a distance measurement target in more detail using a distance measurement technique.

### BRIEF DESCRIPTION OF DRAWINGS

FIG. 1 is a diagram illustrating an example of a configuration of a system according to an embodiment of the present invention.

FIG. 2 is a sequence diagram illustrating an example of a flow of a distance measurement process which is executed by the system according to the present embodiment.

FIG. 3 is a diagram illustrating an example of arrangement of wireless communication units according to the present embodiment.

FIG. 4 is a diagram illustrating an example of a first position identification process according to the present embodiment.

FIG. 5 is a sequence diagram illustrating an example of a flow of a first selection process which is executed by the system according to the present embodiment.

FIG. 6 is a sequence diagram illustrating an example of a flow of the first position identification process which is executed by the system according to the present embodiment.

FIG. 7 is a sequence diagram illustrating an example of a flow of a second position identification process which is executed by a system according to the present modification example.

### DESCRIPTION OF EMBODIMENTS

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

Further, in the present specification and the drawings, different alphabets are suffixed to a same reference numeral to distinguish elements which have substantially the same functional configuration. For example, a plurality of elements which have substantially the same functional configuration are distinguished such as wireless communication units 210A, 210B, and 210C, as necessary. However, when there is no need in particular to distinguish elements that have substantially the same functional configuration, the same reference numeral alone is attached. For example, in the case where it is not necessary to particularly distinguish the wireless communication units 210A, 210B, and 210C, the wireless communication units 210A, 210B, and 210C are simply referred to as the wireless communication units 210.

### 1. Configuration Example

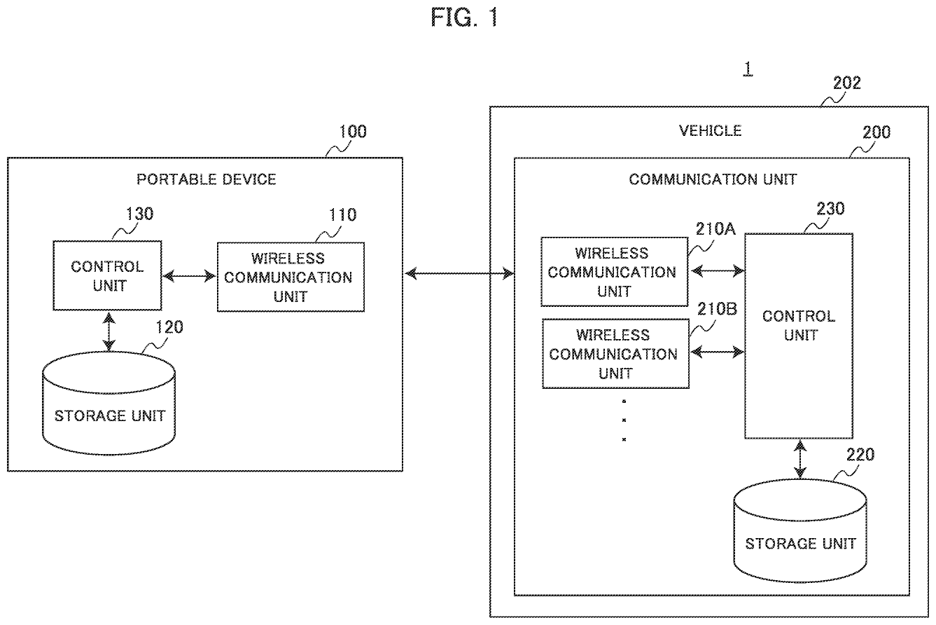

FIG. 1 is a diagram illustrating an example of a configuration of a system 1 according to an embodiment of the present invention. As shown in FIG. 1, the system 1 according to the present embodiment includes a portable device 100 and a communication unit 200. The communication unit 200 in the present embodiment is mounted in a vehicle 202. The vehicle 202 is an example of a user's usage target.

The present invention involves a communication device on the authenticated person side (hereinafter also referred to as a first communication device) and a communication device on an authenticating person side (hereinafter also referred to as a second communication device). In the example shown in FIG. 1, the portable device 100 is an example of the first communication device, and the communication unit 200 is an example of the second communication device.

In the system 1, when a user (for example, a driver of the vehicle 202) approaches the vehicle 202 while carrying the portable device 100, wireless communication for authentication is performed between the portable device 100 and the communication unit 200 mounted in the vehicle 202. When the authentication is successful, the door lock of the vehicle 202 is unlocked or the engine is started, and the vehicle 202 is made available to the user. Such a system is also referred to as a smart entry system. Hereinafter, each component will be described in order.

### (1) Portable Device 100

The portable device 100 is configured as any device which is carried by a user. Examples of any device include an electronic key, a smartphone, a wearable terminal, and the like. As shown in FIG. 1, the portable device 100 includes a wireless communication unit 110, a storage unit 120, and a control unit 130.

### Wireless Communication Unit 110

The wireless communication unit 110 has a function of performing wireless communication with the communication unit 200. In particular, the wireless communication unit 110 performs wireless communication with each of the plurality of wireless communication units 210 included in the communication unit 200. The wireless communication unit 110 receives a wireless signal from the communication unit 200. In addition, the wireless communication unit 110 transmits a wireless signal to the communication unit 200.

The wireless communication performed between the wireless communication unit 110 and the communication unit 200 is performed in accordance with any wireless communication standard.

In an example of a wireless communication standard, signals are transmitted and received using an ultra-wide band (UWB). In a case where an impulse system is used in wireless communication of a signal using a UWB, using radio waves having a very short pulse width of nanoseconds or less allows the airborne propagation time of the radio waves to be measured with a high degree of accuracy and allows distance measurement based on the propagation time to be performed with a high degree of accuracy. The distance measurement involves measuring a distance. Meanwhile, “UWB” often refers to a frequency band of approximately 3 GHz to approximately 10 GHz.

The wireless communication unit 110 is configured as, for example, a communication interface capable of communication in a UWB.

### Storage Unit 120

The storage unit 120 has a function of storing various types of information for the operation of the portable device 100. For example, the storage unit 120 stores a program for the operation of the portable device 100, an identifier (ID) for authentication, a password, an authentication algorithm, and the like. The storage unit 120 is constituted by, for example, a storage medium such as a flash memory and a processing device that executes recording and reproduction on the storage medium.

### Control Unit 130

The control unit 130 has a function of executing processing in the portable device 100. For example, the control unit 130 controls the wireless communication unit 110 to perform wireless communication with the communication unit 200. In addition, information is read out from the storage unit 120 and the information is written to the storage unit 120. In addition, the control unit 130 controls processing for authentication which is performed with the communication unit 200. Examples of the processing for authentication include a distance measurement process, a position identification process, and a selection process which will be described later. The control unit 130 is constituted by an electronic circuit such as, for example, a central processing unit (CPU) and a microprocessor.

### (2) Communication Unit 200

The communication unit 200 is provided in association with the vehicle 202. Here, it is assumed that the communication unit 200 is mounted in the vehicle 202. As an example, the communication unit 200 may be installed in the interior of the vehicle 202. As another example, the communication unit 200 may be built into the vehicle 202 as a communication module. As shown in FIG. 1, the communication unit 200 includes a plurality of wireless communication units 210 (210A, 210B, and the like), a storage unit 220, and a control unit 230.

### Wireless Communication Unit 210

The wireless communication unit 210 has a function of performing wireless communication with the portable device 100. The wireless communication unit 210 receives a wireless signal from the portable device 100. In addition, the wireless communication unit 210 transmits a wireless signal to the portable device 100.

The wireless communication which is performed between the wireless communication unit 210 and the portable device 100 is performed in accordance with any wireless communication standard. Examples of such wireless communication standards include a standard by which a signal is transmitted and received using a UWB. The wireless communication unit 210 is configured as, for example, a communication interface capable of communication in a UWB.

### Storage Unit 220

The storage unit 220 has a function of storing various types of information for the operation of the communication unit 200. For example, the storage unit 220 stores a program for the operation of the communication unit 200, an authentication algorithm, and the like. The storage unit 220 is constituted by, for example, a storage medium such as a flash memory and a processing device that executes recording and reproduction on the storage medium.

### Control Unit 230

The control unit 230 has a function of controlling the overall operation of the communication unit 200 and vehicle-mounted instruments mounted in the vehicle 202. For example, the control unit 230 controls the wireless communication unit 210 to communicate with the portable device 100. In addition, the control unit 230 reads out information from the storage unit 220 and writes the information to the storage unit 220. In addition, the control unit 230 controls processing for authentication which is performed with the portable device 100. Examples of the processing for authentication include a distance measurement process, a position identification process, and a selection process which will be described later.

In addition, the control unit 230 also functions as a door lock control unit that controls the door lock of the vehicle 202, and locks and unlocks the door lock. In addition, the control unit 230 also functions as an engine control unit that controls the engine of the vehicle 202, and starts/stops the engine. Meanwhile, a power source included in the vehicle 202 may be a motor or the like in addition to the engine. The control unit 230 is configured as an electronic circuit such as, for example, an electronic control unit (ECU).

### 2. Technical Feature

### (1) Distance Measurement Process

The portable device 100 and the communication unit 200 perform a distance measurement process. The distance measurement process is a process of measuring a distance between the portable device 100 and the communication unit 200. More precisely, the distance measurement process is a process of measuring a distance between the wireless communication unit 110 of the portable device 100 and the wireless communication unit 210 of the communication unit 200.

In the distance measurement process, a signal for the distance measurement process can be transmitted and received.

An example of the signal for the distance measurement process is a signal for distance measurement. The signal for distance measurement is a signal which is transmitted and received to measure a distance between devices. The signal for distance measurement is also a signal to be measured. For example, the time taken to transmit and receive the signal for distance measurement is measured. The signal for distance measurement is constituted of a frame format that does not have a payload portion for storing data. In the distance measurement process, a plurality of signals for distance measurement can be transmitted and received between devices. A signal for distance measurement which is transmitted from one device to another device among the plurality of signals for distance measurement is also referred to as a first signal for distance measurement. A signal for distance measurement which is transmitted from a device that has received the first signal for distance measurement to a device that has transmitted the first signal for distance measurement is also referred to as a second signal for distance measurement.

Another example of the signal for the distance measurement process is a data signal. The data signal is a signal for storing and transporting data. The data signal is constituted of a frame format that has a payload portion for storing data.

In the distance measurement process, the distance between the wireless communication unit 110 and the wireless communication unit 210 that have transmitted and received the signal for distance measurement is measured as the distance between the portable device 100 and the communication unit 200.

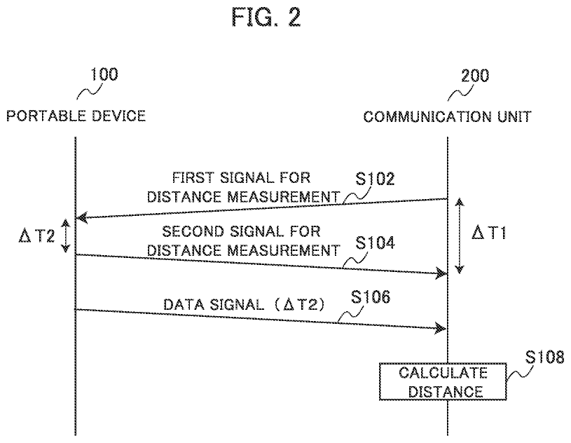

An example of the distance measurement process will be described with reference to FIG. 2.

FIG. 2 is a sequence diagram illustrating an example of a flow of the distance measurement process which is executed by the system 1 according to the present embodiment. As shown in FIG. 2, the portable device 100 and the communication unit 200 are involved in this sequence.

As shown in FIG. 2, first, the wireless communication unit 210 of the communication unit 200 transmits the first signal for distance measurement (step S102). Next, when the first signal for distance measurement is received from the communication unit 200, the wireless communication unit 110 of the portable device 100 transmits the second signal for distance measurement as a response to the first signal for distance measurement (step S104).

In this case, the control unit 130 of the portable device 100 measures a time ΔT2 from the reception time of the first signal for distance measurement to the transmission time of the second signal for distance measurement in the portable device 100. On the other hand, when the second signal for distance measurement is received from the portable device 100, the control unit 230 of the communication unit 200 measures a time ΔT1 from the transmission time of the first signal for distance measurement to the reception time of the second signal for distance measurement in the communication unit 200.

Next, the wireless communication unit 110 of the portable device 100 transmits a data signal including information indicating the time ΔT2 (step S106).

When the data signal is received, the control unit 230 of the communication unit 200 calculates the distance between the portable device 100 and the communication unit 200 on the basis of the measured time ΔT1 and the time ΔT2 indicated by the information contained in the data signal (step S108). Specifically, the propagation time of a one-way signal is calculated by dividing the difference ΔT1−ΔT2 by 2, and the distance between the portable device 100 and the communication unit 200 is calculated by multiplying such a propagation time by the speed of the signal.

### (2) First Position Identification Process

A first position identification process is a process of identifying a position at which the portable device 100 is located. The first position identification process will be described in detail below.

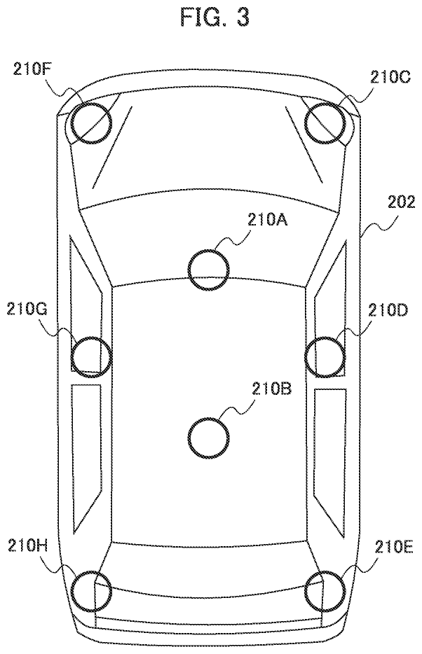

The communication unit 200 is provided with the plurality of wireless communication units 210. An example of arrangement of the wireless communication units 210 will be described with reference to FIG. 3.

FIG. 3 is a diagram illustrating an example of arrangement of the wireless communication units 210 according to the present embodiment. As shown in FIG. 3, the vehicle 202 is provided with wireless communication units 210A to 210H. The positions at which the wireless communication units 210A to 210H are arranged are different from each other.

The control unit 230 identifies position information indicating the position at which the portable device 100 is located on the basis of at least three distance measurement results indicating the distance between each of at least three wireless communication units 210 among the plurality of wireless communication units 210 and the portable device 100 which are obtained in accordance with the result of wireless communication performed by each of the at least three wireless communication units 210. The result of wireless communication herein is the times ΔT1 and ΔT2 taken to transmit and receive the first signal for distance measurement and the second signal for distance measurement in the above-described distance measurement process. The distance measurement result is information indicating the distance between the wireless communication unit 110 and the wireless communication unit 210 that have transmitted and received the first signal for distance measurement and the second signal for distance measurement in the distance measurement process. The control unit 230 performs the above-described distance measurement process using each of the at least three wireless communication units 210. The control unit 230 identifies position information indicating the position of the portable device 100 (more precisely, the position of the wireless communication unit 110) on the basis of at least three distance measurement results obtained by the distance measurement process using each of the at least three wireless communication units 210.

Hereinafter, at least three wireless communication units 210 used to obtain the distance measurement result used to identify the position information indicating the position of the portable device 100 are also referred to as the wireless communication units 210 used for the first position identification process.

The position information indicating the position at which the portable device 100 is located in the present embodiment is information indicating the relative position of the portable device 100 relative to the communication unit 200. Specifically, the position information indicating the position at which the portable device 100 is located is the coordinates of the portable device 100 in a first coordinate system. The first coordinate system is a coordinate system with any position having a fixed position relative to the communication unit 200 (more precisely, each of the plurality of wireless communication units 210) as the origin. An example of the first coordinate system is a coordinate system with the position of any one wireless communication unit 210 among the plurality of wireless communication units 210 as the origin. Another example of the first coordinate system is a coordinate system with any position of the vehicle 202 as the origin. An example of any position of the vehicle 202 is the central point of the vehicle 202.

The storage unit 220 stores information indicating the position of each of the plurality of wireless communication units 210. The information indicating such a position may be coordinates in the first coordinate system. The control unit 230 further identifies the position information indicating the position at which the portable device 100 is located on the basis of the information indicating the position of each of the plurality of wireless communication units 210.

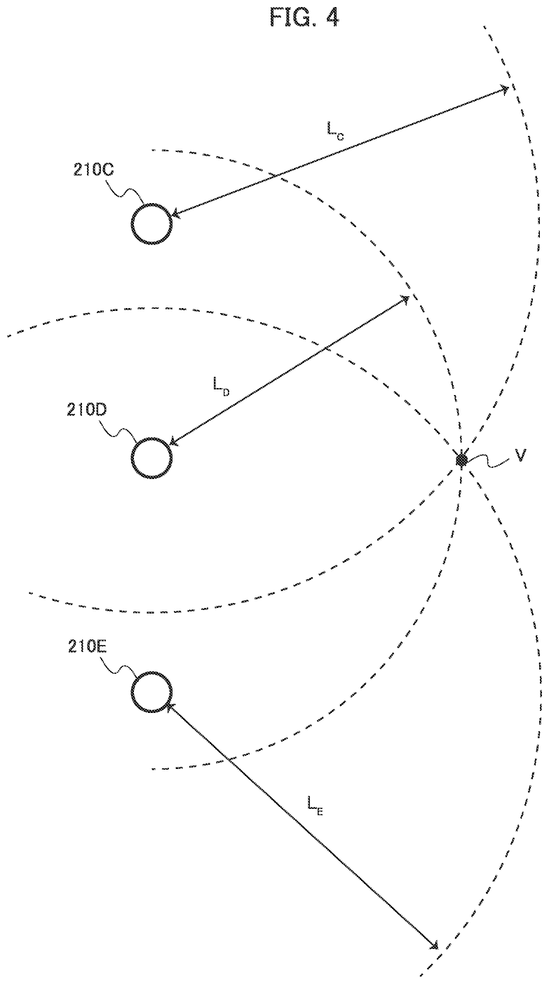

An example of the first position identification process will be described with reference to FIG. 4. FIG. 4 is a diagram illustrating an example of the first position identification process according to the present embodiment. FIG. 4 shows an example in which the position at which the portable device 100 is located is identified on the basis of the distance measurement result obtained in accordance with the result of wireless communication performed by each of the wireless communication units 210C, 210D, and 210E. A distance L_{C} is a distance measurement result obtained in accordance with the result of wireless communication performed by the wireless communication unit 110 and the wireless communication unit 210C. A distance L_{D} is a distance measurement result obtained in accordance with the result of wireless communication performed by the wireless communication unit 110 and the wireless communication unit 210D. A distance L_{E} is a distance measurement result obtained in accordance with the result of wireless communication performed by the wireless communication unit 110 and the wireless communication unit 210E. In the first coordinate system, the control unit 230 identifies coordinates satisfying the conditions that the distance from the coordinates of the wireless communication unit 210C is L_{C}, the distance from the coordinates of the wireless communication unit 210D is L_{D}, and the distance from the coordinates of the wireless communication unit 210E is L_{E} as the position information indicating the position at which the portable device 100 is located. For example, the control unit 230 identifies the coordinates of an intersection point V with a circle of which the radius centered on the coordinates of the wireless communication unit 210C is the distance L_{C}, a circle of which the radius centered on the coordinates of the wireless communication unit 210D is the distance L_{D}, and a circle of which the radius centered on the coordinates of the wireless communication unit 210E is the distance L_{E} as the position information indicating the position at which the portable device 100 is located.

As described above, according to the present embodiment, the position information indicating the position of the portable device 100 is identified. The position information as used herein is the coordinates of the portable device 100 in the first coordinate system. Therefore, according to the present embodiment, it is possible to identify the position of the portable device 100 in detail instead of a simple distance measurement process.

The position information indicating the position of the portable device 100 identified by the first position identification process is used for authentication which is performed between the portable device 100 and the communication unit 200. For example, the authentication succeeds in a case where the position of the portable device 100 indicated by the identified position information is included in a specified range, and the authentication fails in a case where it is not included in the specified range.

### (3) First Selection Process

A first selection process is a process of selecting a wireless communication unit 210 used for the first position identification process. The communication unit 200 may include four or more wireless communication units 210 as a plurality of wireless communication units 210. In that case, at least three wireless communication units 210 are selected from the four or more wireless communication units 210 as the wireless communication units 210 used for the first position identification process.

The control unit 230 selects at least three wireless communication units 210 as the wireless communication units 210 used for the first position identification process on the basis of the distance measurement result obtained in accordance with the result of wireless communication performed by each of the plurality of wireless communication units 210. The control unit 230 performs the distance measurement process using each of the plurality of wireless communication units 210 included in the communication unit 200. The control unit 230 selects the wireless communication units 210 used for the first position identification process on the basis of the obtained plurality of distance measurement results. Thereafter, the control unit 230 identifies the position information indicating the position at which the portable device 100 is located on the basis of at least three distance measurement results indicating the distance between each of the at least three wireless communication units 210 selected as the wireless communication units 210 used for the first position identification process and the portable device 100.

Selecting the wireless communication units 210 used for the first position identification process includes selecting at least three wireless communication units 210 in ascending order of distance from the portable device 100 indicated by the distance measurement result. Specifically, the control unit 230 compares the magnitude of the distance between each of the plurality of wireless communication units 210 and the portable device 100 which is measured in the distance measurement process performed using each of the plurality of wireless communication units 210. The control unit 230 selects at least three wireless communication units 210 in ascending order of distance to the portable device 100. Thereby, the influence of a multi path can be reduced, and thus it is possible to improve the accuracy of position identification. This point will be described in detail below. Meanwhile, the accuracy of position identification is the degree of accuracy of the position information identified by a position information identification process.

The term “multi path” refers to a state in which multiple radio waves transmitted from one transmission source reach the reception side. The multi path occurs in a case where there are a plurality of paths between transmission and reception. In particular, the multi path occurs in a case where there is a shielding object that shields radio waves on a straight path between the transmission source and the reception side. In a situation where the multi path is occurring, signals having passed through a plurality of different paths can reach the reception side at the same time and be received in a synthesized state. In impulse-type wireless communication, in a case where pulses having phases different from each other as a result of having passed through paths different from each other are received in a synthesized state, the pulses may cancel out each other. As a result, a pulse arriving later than the canceled pulse is detected on the reception side, and thus a delay may occur at the time when the pulse is detected on the reception side. In the distance measurement process of measuring a distance on the basis of the time taken to transmit and receive a signal for distance measurement (pulse), a distance longer than the actual distance is measured by the amount of delay in the reception time of the signal for distance measurement. In this regard, in the present embodiment, the position information indicating the position of the portable device 100 is prevented from being identified on the basis of a distance longer than the actual distance by selecting the wireless communication unit 210 in ascending order of distance measured in the distance measurement process. Therefore, it is possible to improve the accuracy of position identification.

The distance of which the magnitude is compared when the wireless communication units 210 used for the first position identification process are selected may be a minimum value among a plurality of distances indicated by a plurality of distance measurement results obtained in accordance with the result of wireless communication repeatedly performed for each the wireless communication unit 210. Specifically, the control unit 230 repeatedly performs the distance measurement process using each of the plurality of wireless communication units 210 for each the wireless communication unit 210. Next, the control unit 230 acquires a minimum value among a plurality of distances measured in the distance measurement process repeatedly performed for each the wireless communication unit 210 for each of the plurality of wireless communication units 210. The control unit 230 selects at least three wireless communication units 210 in ascending order of the minimum value of distance to the portable device 100 acquired for each of the plurality of wireless communication units 210. Thereby, the influence of the multi path can be reduced for the same reason as the reason described above, and thus it is possible to improve the accuracy of position identification.

Selecting the wireless communication units 210 used for the first position identification process may include selecting wireless communication units 210 that have performed wireless communication for which the distance measurement result indicating a distance matching the position at which the portable device 100 is assumed to be located is obtained. The position at which the portable device 100 is assumed to be located is, for example, the interior and exterior of the vehicle 202. For example, in a case where the portable device 100 is assumed to be located in the vehicle interior, the control unit 230 selects wireless communication units 210 that have performed wireless communication for which a distance measurement result indicating a distance shorter than a predetermined threshold is obtained as selection candidates. The control unit 230 selects wireless communication units 210 used for the first position identification process from the wireless communication units 210 which are selection candidates. The predetermined threshold as used herein is a distance between a position farthest from the wireless communication unit 210 in the vehicle interior and the position of the wireless communication unit 210. Thereby, the first position information identification process can be performed on the basis of the distance measurement result that matches the position at which the portable device 100 is assumed to be located, and thus it is possible to improve the accuracy of position identification.

Meanwhile, as an example, the position at which the portable device 100 is assumed to be located can be determined on the basis of the time-series transition of the distance measurement result. For example, in a case where the distance indicated by the distance measurement result decreases or increases gradually, it is considered that a user is approaching or far from the vehicle 202 while carrying the portable device 100, and thus the portable device 100 is assumed to be located in the vehicle exterior. As another example, the position at which the portable device 100 is assumed to be located can be determined on the basis of the state of the vehicle 202. For example, in a case where the door of the vehicle 202 is opened and closed after the distance indicated by the distance measurement result decreases gradually, it is considered that the user has entered the vehicle interior while carrying the portable device 100, and thus the portable device 100 is assumed to be located in the vehicle interior.

The control unit 230 may stop wireless communication performed by the wireless communication unit 210 other than the wireless communication units 210 used for the first position identification process among the plurality of wireless communication units 210. The control unit 230 may cause only the wireless communication units 210 used for the first position identification process to perform wireless communication and perform the distance measurement process and the first position identification process. Thereby, the number of wireless communication units 210 that perform wireless communication can be reduced, and thus it is possible to suppress power consumption.

When the first selection process is executed, the control unit 230 may restart wireless communication performed by the wireless communication unit 210 other than the wireless communication units 210 used for the first position identification process. Thereby, the control unit 230 can select the wireless communication units 210 used for the first position identification process from many wireless communication units 210 as compared with the case where the restart is not performed.

In addition, the wireless communication which is executed in the first selection process may be the same as the wireless communication which is executed in the first position identification process. In other words, the distance measurement result obtained by a one-time distance measurement process may be used for both the first selection process and the first position identification process. For example, the distance measurement process may be performed using each of the plurality of wireless communication units 210, the first selection process may be executed on the basis of the obtained plurality of distance measurement results, and the first position information identification process may be executed on the basis of the distance measurement result obtained by the selected wireless communication unit 210. Thereby, the number of wireless communications can be reduced, and thus it is possible to improve the efficiency of the process.

### (4) Flow of Processing

### First Selection Process

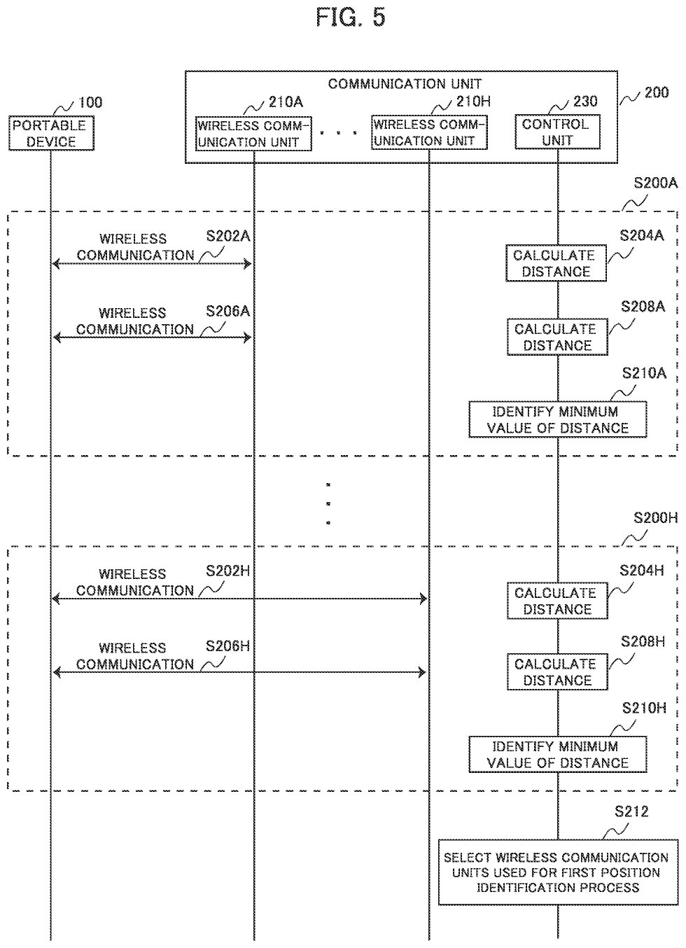

FIG. 5 is a sequence diagram illustrating an example of a flow of the first selection process which is executed by the system 1 according to the present embodiment. As shown in FIG. 5, the portable device 100 and the communication unit 200 are involved in this sequence. This sequence is a sequence in an example in which the wireless communication units 210A to 210H shown in FIG. 3 are arranged in the vehicle 202. In this sequence, for a process in which each of the plurality of wireless communication units 210 is involved, a sign containing the same alphabet as the alphabet attached to the end of the wireless communication unit 210 is attached at the end. For example, step S200A is attached to a process in which the wireless communication unit 210A is involved, and step S200H is attached to a process in which the wireless communication unit 210H is involved.

As shown in FIG. 5, first, the portable device 100 and the communication unit 200 perform the distance measurement process using the wireless communication unit 110 and the wireless communication unit 210A (steps S202A and S204A). Specifically, wireless communication is executed between the wireless communication unit 210A and the wireless communication unit 110 (step S202A). For example, as described above with reference to FIG. 2, the first signal for distance measurement, the second signal for distance measurement, and the data signal are transmitted and received between the wireless communication unit 210A and the wireless communication unit 110. Next, the control unit 230 calculates the distance between the wireless communication unit 210A and the portable device 100 in accordance with the result of wireless communication in step S202A (step S204A). These processes are as described above with reference to FIG. 2.

Next, the portable device 100 and the communication unit 200 perform the distance measurement process using the wireless communication unit 110 and the wireless communication unit 210A again (steps S206A and 5208A). The processes of steps S206A and 108A are the same as the processes of steps S202A to 5204A, and thus detailed description herein will be omitted.

The control unit 230 identifies the minimum value among the plurality of distances indicated by the plurality of distance measurement results obtained by the distance measurement process performed multiple times (step S210A). In the present example, the control unit 230 compares the distance calculated in step S204A with the distance calculated in step S208A and identifies the smaller one as the minimum value.

The portable device 100 and the communication unit 200 perform the same processes as the processes of steps S202A to 5210A (step S200A) with respect to all the wireless communication units 210. In FIG. 5, in addition to a process 100A in which the wireless communication unit 210A is involved, a process 100H in which the wireless communication unit 210H is involved is shown, and a process in which the wireless communication units 210B to 210G are involved is not shown. The processes of steps S202H to 5210H in the process 100H in which the wireless communication unit 210H is involved are the same as the processes of steps S202A to 5210A in the process 100A in which the wireless communication unit 210A is involved, and thus detailed description herein will be omitted.

Thereafter, the control unit 230 selects the wireless communication units 210 used for the first position identification process from the wireless communication units 210A to 210H (step S212). Specifically, at least three wireless communication units 210 are selected in ascending order of the minimum value of distance to the portable device 100 obtained in steps S210A to 5210H.

### First Position Identification Process

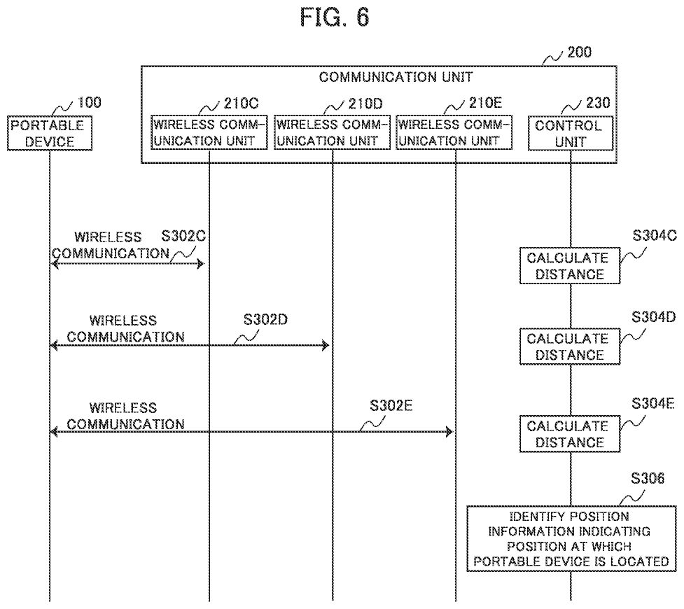

FIG. 6 is a sequence diagram illustrating an example of a flow of the first position identification process which is executed by the system 1 according to the present embodiment. As shown in FIG. 6, the portable device 100 and the communication unit 200 are involved in this sequence. This sequence is a sequence in a case where the wireless communication units 210C, 210D, and 210E are selected by the first selection process in an example in which the wireless communication units 210A to 210H shown in FIG. 3 are arranged in the vehicle 202. In this sequence, similarly to FIG. 5, for a process in which each of the plurality of wireless communication units 210 is involved, a sign containing the same alphabet as the alphabet attached to the end of the wireless communication unit 210 is attached at the end.

As shown in FIG. 6, first, the portable device 100 and the communication unit 200 perform the distance measurement process using the wireless communication unit 110 and the wireless communication unit 210C (steps S302C and 5304C). Specifically, wireless communication is executed between the wireless communication unit 210C and the wireless communication unit 110 (step S302C). For example, as described above with reference to FIG. 2, the first signal for distance measurement, the second signal for distance measurement, and the data signal are transmitted and received between the wireless communication unit 210C and the wireless communication unit 110. Next, the control unit 230 calculates the distance between the wireless communication unit 210C and the portable device 100 in accordance with the result of wireless communication in step S302C (step S304C).

Next, the portable device 100 and the communication unit 200 perform the distance measurement process using the wireless communication unit 110 and the wireless communication unit 210D (steps S302D and S304D). The processes of steps S302D and S304D are the same as the processes of steps S302C to S304C, and thus detailed description herein will be omitted.

Next, the portable device 100 and the communication unit 200 perform the distance measurement process using the wireless communication unit 110 and the wireless communication unit 210E (steps S302E and S304E). The processes of steps S302E and S304E are the same as the processes of steps S302C to S304C, and thus detailed description herein will be omitted.

The control unit 230 identifies the position information indicating the position at which the portable device 100 is located on the basis of the three distance measurement results obtained in steps S304C, S304D, and S304E (step S306). The processing herein is as described above with reference to FIG. 4.

### 3. Modification Example

Although the position information indicating the position at which the portable device 100 is located is identified by the communication unit 200 in the above embodiment, the present invention is not limited to such an example. The position information indicating the position at which the communication unit 200 is located may be identified by the portable device 100. This point will be described in detail below.

### (1) Configuration

The configurations of the portable device 100 and the communication unit 200 according to the present modification example are as described above with reference to FIG. 1.

### (2) Distance Measurement Process

The distance measurement process according to the present modification example is a process of measuring the distance between the portable device 100 and the communication unit 200 similarly to the distance measurement process according to the above embodiment. More precisely, the distance measurement process according to the present modification example is a process of measuring the distance between the wireless communication unit 110 of the portable device 100 and the wireless communication unit 210 of the communication unit 200 similarly to the distance measurement process according to the above embodiment.

In the present modification example, the portable device 100 acquires information indicating the distance between the portable device 100 and the communication unit 200. As an example, the distance measurement result obtained by the distance measurement process described above with reference to FIG. 2 may be reported from the communication unit 200 to the portable device 100. As another example, the control unit 130 may calculate information indicating the distance between the portable device 100 and the communication unit 200 by reversing the execution entity of each step in the distance measurement process described above with reference to FIG. 2 between the portable device 100 and the communication unit 200.

### (3) Second Position Identification Process

A second position identification process is a process of identifying the position at which the communication unit 200 is located.

The control unit 130 identifies the position information indicating the position at which the communication unit 200 is located on the basis of at least three distance measurement results indicating the distance between the portable device 100 (more precisely, the wireless communication unit 110) and each of at least three wireless communication units 210 obtained in accordance with the result of wireless communication performed between the wireless communication unit 110 and the at least three wireless communication units 210. The result of wireless communication herein is the times ΔT1 and ΔT2 taken to transmit and receive the first signal for distance measurement and the second signal for distance measurement in the above-described distance measurement process. The distance measurement result is information indicating the distance between the wireless communication unit 110 and the wireless communication unit 210 that have transmitted and received the first signal for distance measurement and the second signal for distance measurement in the distance measurement process. The control unit 130 performs the distance measurement process with each of the at least three wireless communication units 210 as a wireless communication partner. The wireless communication partner herein is the wireless communication unit 210 that transmits and receives the first signal for distance measurement and the second signal for distance measurement to and from the wireless communication unit 110. The control unit 130 identifies the position information indicating the position of the communication unit 200 on the basis of at least three distance measurement results obtained by the distance measurement process in which each of the at least three wireless communication units 210 is used as a wireless communication partner.

Hereinafter, in order to obtain the distance measurement result used to identify the position information indicating the position of the communication unit 200, at least three wireless communication units 210 which are wireless communication partners of the wireless communication unit 110 are also referred to as the wireless communication units 210 used for the second position identification process.

The position information indicating the position at which the communication unit 200 is located in the present modification example is information indicating the relative position of the communication unit 200 relative to the portable device 100. Specifically, the position information indicating the position at which the communication unit 200 is located is the coordinates of the communication unit 200 in a second coordinate system. The second coordinate system is a coordinate system with any position having a fixed position relative to the portable device 100 (more precisely, the wireless communication unit 110) as the origin. An example of the second coordinate system is a coordinate system with the position of the wireless communication unit 110 as the origin. Another example of the second coordinate system is a coordinate system with any position of the portable device 100 as the origin. An example of any position of the portable device 100 is the central point of the portable device 100.

In addition, an example of the position information indicating the position at which the communication unit 200 is located in the present modification example is the coordinates of the wireless communication units 210 used for the second position identification process in the second coordinate system. Another example of the position information indicating the position at which the communication unit 200 is located in the present modification example is the coordinates of any position of the vehicle 202 in the second coordinate system. An example of any position of the vehicle 202 is the central point of the vehicle 202.

The storage unit 120 stores information indicating the position of each of the plurality of wireless communication units 210. The information indicating such a position may be coordinates in the first coordinate system. The control unit 130 further identifies the position information indicating the position at which the communication unit 200 is located on the basis of the information indicating the position of each of the plurality of wireless communication units 210.

An example of the second position identification process will be described with reference to FIG. 4 again. In the first coordinate system, the control unit 130 identifies coordinates satisfying the conditions that the distance from the coordinates of the wireless communication unit 210C is L_{C}, the distance from the coordinates of the wireless communication unit 210D is L_{D}, and the distance from the coordinates of the wireless communication unit 210E is L_{E} as the position information indicating the position at which the portable device 100 (more precisely, the wireless communication unit 110) is located. Here, the position of the portable device 100 is the origin in the second coordinate system. Consequently, the control unit 130 converts the coordinates of the wireless communication units 210C, 210D, and 210E in the first coordinate system into the coordinates in the second coordinate system on the basis of the identified coordinates of the portable device 100 in the first coordinate system. Thereby, the coordinates of the wireless communication units 210C, 210D, and 210E in the second coordinate system can be identified as the position information indicating the position at which the communication unit 200 is located.

As described above, according to the present modification example, the position information indicating the position of the communication unit 200 is identified. The position information herein is the coordinates of the communication unit 200 in the second coordinate system. Therefore, according to the present modification example, it is possible to identify the position of the communication unit 200 in detail instead of a simple distance measurement process.

The position information indicating the position of the communication unit 200 identified by the second position identification process is used for authentication which is performed between the portable device 100 and the communication unit 200. For example, the authentication succeeds in a case where the position of the communication unit 200 indicated by the identified position information is included in a specified range, and the authentication fails in a case where it is not included in the specified range.

### (4) Second Selection Process

The second selection process is a process of selecting the wireless communication units 210 used for the second position identification process. The communication unit 200 may include four or more wireless communication units 210 as the plurality of wireless communication units 210. In that case, at least three wireless communication units 210 are selected from the four or more wireless communication units 210 as the wireless communication units 210 used for the second position identification process.

The control unit 130 selects at least three wireless communication units 210 as the wireless communication units 210 used for the second position identification process on the basis of the distance measurement result obtained in accordance with the result of wireless communication performed between the wireless communication unit 110 and each of the plurality of wireless communication units 210. The control unit 130 performs the distance measurement process with each of the plurality of wireless communication units 210 included in the communication unit 200 as a wireless communication partner. The control unit 230 selects the wireless communication units 210 used for the second position identification process on the basis of the obtained plurality of distance measurement results. Thereafter, the control unit 130 identifies the position information indicating the position at which the communication unit 200 is located on the basis of at least three distance measurement results indicating the distance between each of the at least three wireless communication units 210 selected as the wireless communication units 210 used for the second position identification process and the portable device 100.

The content of the second selection process is the same as that of the first position identification process except that the main entity that identifies the position information is the control unit 130.

### (5) Flow of Processing

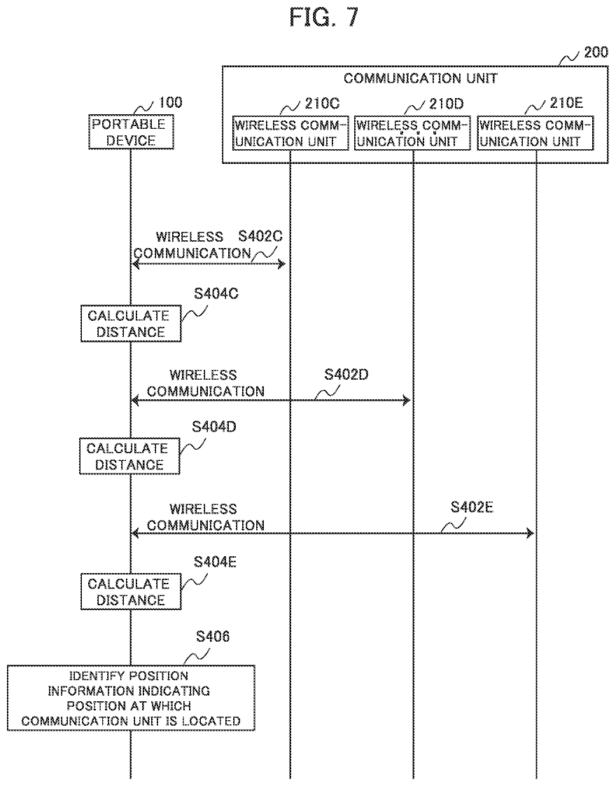

FIG. 7 is a sequence diagram illustrating an example of a flow of the second position identification process which is executed by the system 1 according to the present modification example. As shown in FIG. 7, the portable device 100 and the communication unit 200 are involved in this sequence. This sequence is a sequence in a case where the wireless communication units 210C, 210D, and 210E are selected by the second selection process in an example in which the wireless communication units 210A to 210H shown in FIG. 3 are arranged in the vehicle 202. In this sequence, similarly to FIG. 5, for a process in which each of the plurality of wireless communication units 210 is involved, a sign containing the same alphabet as the alphabet attached to the end of the wireless communication unit 210 is attached at the end.

As shown in FIG. 7, first, the portable device 100 and the communication unit 200 perform the distance measurement process using the wireless communication unit 110 and the wireless communication unit 210C (steps S402C and S404C). In the present distance measurement process, the distance measurement process described above with reference to FIG. 2 is executed by reversing the execution entity of each step between the portable device 100 and the communication unit 200. Specifically, wireless communication is executed between the wireless communication unit 210C and the wireless communication unit 110 (step S402C). Next, the control unit 130 calculates the distance between the wireless communication unit 210C and the portable device 100 in accordance with the result of wireless communication in step S402C (step S404C).

Next, the portable device 100 and the communication unit 200 perform the distance measurement process using the wireless communication unit 110 and the wireless communication unit 210D (steps S402D and 5404D). The processes of steps S402D and 5404D are the same as the processes of steps S402C to 5404C, and thus detailed description herein will be omitted.

Next, the portable device 100 and the communication unit 200 perform the distance measurement process using the wireless communication unit 110 and the wireless communication unit 210E (steps S402E and S404E). The processes of steps S402E and 5404E are the same as the processes of steps S402C to 5404C, and thus detailed description herein will be omitted.

The control unit 130 identifies the position information indicating the position at which the communication unit 200 is located on the basis of the three distance measurement results obtained in steps S404C, S404D, and S404E (step S406). The processing herein is as described above with reference to FIG. 4.

### 4. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

For example, it has been described that distance measurement is performed on the basis of the time taken to transmit and receive a signal for distance measurement in the above embodiment, but the present invention is not limited to such an example. Distance measurement may be performed on the basis of received power when a signal for distance measurement transmitted by one of the portable device 100 and the communication unit 200 is received by the other. In addition, distance measurement may be performed using a global navigation satellite system (GNSS).

For example, a UWB is used as a wireless communication standard in the above embodiment, but the present invention is not limited to such an example. For example, Bluetooth Low Energy (BLE (registered trademark)), and Wi-Fi (registered trademark) may be used as wireless communication standards.

For example, an example in which the present invention is applied to a smart entry system has been described in the above embodiment, but the present invention is not limited to such an example. The present invention can be applied to any system that acquires position information by transmitting and receiving a signal. For example, the present invention can be applied to a pair including any two devices such as portable devices, vehicles, smartphones, drones, houses, and home electric appliances. One of the pairs is provided with at least three wireless communication units. One of the pairs acquires position information of the other. Meanwhile, the pair may include two devices of the same type, or may include two different types of devices.

Note that, a series of processes performed by the devices described in this specification may be achieved by any of software, hardware, and a combination of software and hardware. A program that configures software is stored in advance in, for example, a recording medium (non-transitory medium) installed inside or outside the devices. In addition, for example, when a computer executes the programs, the programs are read into random access memory (RAM), and executed by a processor such as a CPU. The recording medium may be a magnetic disk, an optical disc, a magneto-optical disc, flash memory, or the like. Alternatively, the above-described computer program may be distributed via a network without using the recording medium, for example.

Further, in the present specification, the processes described using the flowcharts are not necessarily executed in the order illustrated in the drawings. Some processing steps may be executed in parallel. In addition, additional processing steps may be employed and some processing steps may be omitted.

### REFERENCE SIGNS LIST

1 System
100 Portable device
110 Wireless communication unit
120 Storage unit
130 Control unit
200 Communication unit
202 Vehicle
210 Wireless communication unit
220 Storage unit
230 Control unit

1. A communication device comprising:
a plurality of wireless communication units configured to perform wireless communication with another communication device; and
a control unit configured to identify position information indicating a position at which the other communication device is located on the basis of at least three distance measurement results indicating a distance between each of at least three wireless communication units and the other communication device obtained in accordance with a result of wireless communication performed by each of the at least three wireless communication units among the plurality of wireless communication units.

2. The communication device according to claim 1, wherein the control unit selects the at least three wireless communication units on the basis of the plurality of distance measurement results obtained in accordance with the result of wireless communication performed by each of the plurality of wireless communication units, and identifies position information indicating a position at which the other communication device is located on the basis of at least three distance measurement results indicating a distance between each of the three selected wireless communication units and the other communication device.

3. The communication device according to claim 2, wherein selecting the at least three wireless communication units includes selecting at least three of the wireless communication units in ascending order of distance from the other communication device indicated by the distance measurement result.

4. The communication device according to claim 3, wherein the distances whose magnitudes are compared when the at least three wireless communication units are selected are a minimum value among a plurality of distances indicated by the plurality of distance measurement results obtained in accordance with the result of wireless communication repeatedly performed for each of the wireless communication units.

5. The communication device according to claim 2, wherein selecting the at least three wireless communication units includes selecting the wireless communication unit that has performed wireless communication for which the distance measurement result indicating a distance matching a position at which the other communication device is assumed to be located is obtained.

6. The communication device according to claim 1, wherein the control unit stops wireless communication performed by the wireless communication unit other than the at least three wireless communication units among the plurality of wireless communication units.

7. The communication device according to claim 1, wherein the communication device is mounted in a vehicle, and
the other communication device is a device which is carried and used by a user of the vehicle.

8. A communication device comprising:
a wireless communication unit configured to perform wireless communication with each of a plurality of other wireless communication units provided in another communication device; and
a control unit configured to identify position information indicating a position at which the other communication device is located on the basis of at least three distance measurement results indicating a distance between the communication device and each of at least three other wireless communication units obtained in accordance with a result of wireless communication performed between the wireless communication unit and the at least three other wireless communication units.

9. A position identification method comprising identifying position information indicating a position at which another communication device is located on the basis of at least three distance measurement results indicating a distance between each of at least three wireless communication units and the other communication device obtained in accordance with a result of wireless communication performed by each of the at least three wireless communication units among a plurality of wireless communication units that perform wireless communication the other communication device.

10. (canceled)
